(19) United States
(12) Patent Application Publication
(10) Pub. No.: US 2025/0355083 A1
(43) Pub. Date: Nov. 20, 2025

(54) INCREASING SUCCESS PROBABILITY FOR MISSILE STRIKE PACKAGES

(71) Applicant: L3Harris Technologies, Inc., Melbourne, FL (US)

(72) Inventor: Travis COVERT, McKinney, TX (US)

(21) Appl. No.: 18/332,307

(22) Filed: Jun. 9, 2023

(51) Int. Cl. G01S 7/38; F41H 11/02; F42B 15/01; G01S 7/02

(52) U.S. Cl. CPC G01S 7/38; F41H 11/02; F42B 15/01; G01S 7/021; G01S 7/027

(57) ABSTRACT

An electronic protection (EP) missile has its warhead unit replaced by an electronic warfare (EW) pod which functions to jam enemy air defenses to protect the other missiles in a long rage strike package throughout a mission. The EP missile is otherwise configured similar to armed missiles with which it is launched as part of the strike package.

### TECHNICAL FIELD

The present disclosure pertains to systems and methods for increasing the number of successful missile strikes from a multiple missile strike package and, more particularly, to protecting missiles in the strike package against enemy countermeasures.

### BACKGROUND

Cruise missile strike packages have a predictable probability of success; that is, when a multiple missile package is launched, it is known that some of the missiles will be detected and tracked by enemy radar or other tracking systems and shot down or otherwise deterred so as to not reach the intended target. This less than 100% success probability means that more missiles are launched than are necessary to achieve a successful mission. For example, if one hundred cruise missiles are launched at some targets located deep inside a protected enemy area, the success probability may be seventy percent, in which case it is expected that thirty missiles will be shot down and lost at a considerable waste of resources. The problem addressed herein is how to increase the probability of successful strikes by individual missiles in a missile package so that the number of missiles in a package can be reduced without sacrificing the goal of the mission. It should be noted that this problem is primarily applicable to long range missile strikes aimed at targets located beyond the first line of enemy air defenses since Stand Off Jammers (SOJ) are effective in countering those defenses.

One approach to addressing the previously mentioned problem would be to install in each missile in the strike package an electronic warfare (EW) pod that could detect enemy tracking systems and respond either by jamming that signal or changing the course for that missile. However, apart from cost considerations, cruise missiles are severely limited in size, weight and power (SWaP), making it impractical to install a meaningful EW pod for self-protection in each missile.

In published US Patent Application Publication No. US20210109192 (Keegan et al), the entire disclosure in which is incorporated herein by reference, there is disclosed a system for launching a projectile round carrying a detachable electronic warfare (EW) asset having a deployable parachute. The EW asset is configured to be suspended from the slowly descending parachute when the EW asset is detached from the projectile round. Examples of the effects that the EW asset can achieve include self-protection, standoff and escort jamming, and other spoofing and/or jamming effects. While this approach has certain benefits, once the parachute is deployed the EW asset is limited in range and geographic scope and cannot protect missiles in the package throughout their entire mission.

Another prior art system is the MALD-J (miniature air-launched decoy-jammer), an air launched EW asset that receives ground signals and returns them back to the source at an amplified level to mimic any aircraft, thus mimicking an actual aircraft and distracting enemy ground radar away from its intended targets. The MALD-J craft are specially configured at considerable expense and are limited in detection range to approximately five hundred miles.

The systems and methods disclosed herein address the aforesaid problems. More specifically, the disclosed systems and methods increase the efficiency of a multiple missile strike package by increasing the probability of successful strikes by individual missiles in the package.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

In accordance with the principles disclosed herein, an electronic protection (EP) missile has its warhead unit replaced by an electronic warfare (EW) pod. The EP missile is otherwise configured similar to armed missiles with which it is launched as part of a long-range missile strike package. The EW pod of the EP missile functions to jam enemy air defenses to protect the other missiles in the strike package throughout its mission. Because the EW pod in the protection missile is configured to be integrated into the space originally designed for the warhead, the EP missile has the same external configuration as the armed missiles in the strike package. The EW pod is self-contained and requires only minimal reliance on other systems in the protection missile for its operation. The EP missile accompanies the armed missiles in relatively close proximity and is capable of continuously detecting and jamming enemy defense radar to protect the entire package of missiles throughout their mission. In addition, the EP missile may communicate with the armed missiles, directly or via a home base, to cause any or all of them to change flight paths during the mission to avoid enemy threats. In a typical system, an EP missile may be employed to protect twenty, fifty, or more armed missiles in a strike package. In addition, two or more EP missiles may be deployed with, and protect respective groups of, missiles in a larger missile strike package.

Accordingly, in one aspect the present disclosure is directed to a cruise missile system comprising: an aerodynamic missile body; a propulsion subsystem disposed in the missile body; a missile control subsystem disposed in the missile body; a fuel tank disposed in the missile body; a warhead space in the missile body configured to receive a warhead; and an electronic warfare pod disposed in the warhead space instead of a warhead.

One of the advantages of the disclosed arrangement is its ability to extend the range of protection for long range missiles. Previously, electronic warfare protection for such missiles has been limited to the range of positionally fixed detection and jamming systems, i.e., approximately five hundred miles. This is less than adequate for long range missiles that have mission ranges far beyond that. Notably, the EP missile does not serve as a decoy; rather, its EW pod, in effect, creates an active EW asset platform that travels with and protects the armed missiles far beyond previously achievable protective range limitations.

Another advantage of the disclosed system is that it eliminates the need for dispersing the missiles in a strike package to minimize detection and countermeasure strikes. Specifically, the armed missiles may be provided with datalinks permitting the protection missile to communicate with them and change their routes, literally “on the fly”, upon detection of a threat.

### BRIEF DESCRIPTION OF THE DRAWINGS

By way of example, specific illustrative embodiments of the present disclosure will now be described with reference to the accompanying drawings.

FIG. 1 is a diagrammatic perspective view of a missile configured to serve as a protection missile in accordance with the principles disclosed herein.

FIG. 2 is a block diagram showing the components of an EW pod employed in protection missile.

FIG. 3 is a schematic illustration of an example of a deployment of the protection missile of FIG. 1 in a missile strike package.

FIG. 4. Is a functional block diagram illustrating operation of the protection missile during a mission.

### DETAILED DESCRIPTION OF EXAMPLE EMBODIMENTS

The present systems and methods are described more fully hereinafter with reference to the accompanying drawings, in which several exemplary embodiments are shown. It will be readily understood that the components of the embodiments as generally described herein and illustrated in the appended drawings may be arranged and designed in a wide variety of different configurations. Thus, the following more detailed description of various embodiments, as represented in the drawings, is not intended to limit the scope of the present disclosure but is merely representative of various embodiments. While the various aspects of the embodiments are presented in the drawings, the drawings are not necessarily drawn to scale unless specifically indicated.

The subject matter disclosed herein may be embodied in other specific forms without departing from its spirit or essential characteristics; that is, the described embodiments are to be considered in all respects only as illustrative and not restrictive. The scope of the invention(s) is/are, therefore, indicated by the appended claims rather than by this detailed description. All changes that come within the meaning and range of equivalency of the claims are to be embraced within their scope.

Reference throughout this specification to features, advantages, or similar language does not imply that all the features and advantages that may be realized with the disclosed apparatus, system and method should be or are in any single embodiment. Rather, language referring to the features and advantages is understood to mean that a specific feature, advantage, or characteristic described in connection with an embodiment is included in at least one embodiment. Thus, discussions of the features and advantages, and similar language, throughout this specification may, but do not necessarily, refer to the same embodiment.

Furthermore, the described features, advantages, and characteristics of the disclosed systems may be combined in any suitable manner in one or more embodiments. One skilled in the relevant art will recognize, in light of the description herein, that the embodiments can be practiced without one or more of the specific features or advantages of a particular embodiment. In other instances, additional features and advantages may be recognized in certain embodiments that may not be present in all embodiments.

Reference throughout this specification to “one embodiment,” “an embodiment,” or similar language means that a particular feature, structure, or characteristic described in connection with the indicated embodiment is included in at least one embodiment. Thus, the phrases “in one embodiment,” “in an embodiment,” and similar language throughout this specification may, but do not necessarily, all refer to the same embodiment.

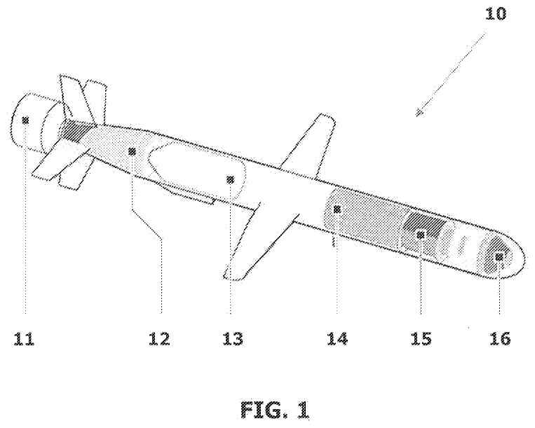

Referring specifically to FIG. 1, a cruise missile modified to function as an electronic protection (EP) missile is illustrated as comprising an aerodynamic missile body 10 and a propulsion subsystem including a solid fuel booster 11 typically located for launch at the rearward or aft end of body 10 and an engine 12, typically a jet engine, located in the missile body immediately forward of the booster. A fuel tank 13 for supplying fuel to the engine is typically located immediately forward of the engine. A missile control system includes a targeting subsystem 16 at the forward end of the missile and a navigation subsystem 15 located immediately behind the targeting subsystem. All of these missile components and subsystems are conventional and may be any conventional components and subsystems commonly used for accomplishing their intended functions as parts of a typical cruise missile. For example, navigation system 15 and targeting system 16 may comprise any one or more of the following types of subsystems configured to cooperatively effect the intended guidance and targeting: inertial guidance (IGS) which keeps track of the missile's location based on acceleration detected in the missile's motion; Terrain Control Matching (TERCOM) which matches radar data to an on-board database containing terrain data; Global Positioning System (GPS); Digital Scene Matching Area Correlation system (DSMAC) which uses a camera and an image correlator to locate the target. In accordance with the principles of this disclosure, an electronic warfare (EW) pod 14 is disposed in the missile body 10, preferably between the navigation subsystem 15 and fuel tank 13 in the space typically occupied by and configured for a missile warhead.

The EW pod 14 may be placed in the missile when the missile is manufactured, or the missile 10 may be retrofitted by removing its warhead and replacing it with the EW pod. In either case, EW pod is designed to conform to the space in the missile originally designed for the warhead. As a result, the EP missile 10, visually and under radar detection, appears the same as an armed missile. Since the EP missile 10 has the same propulsion and guidance subsystems as armed missiles, it is readily launched and guided in the same manner as the other missiles in a missile strike package. Otherwise stated, the EP missile, whether originally designed with or retrofitted to contain the EW pod, has a form factor identical to an armed missile containing a warhead.

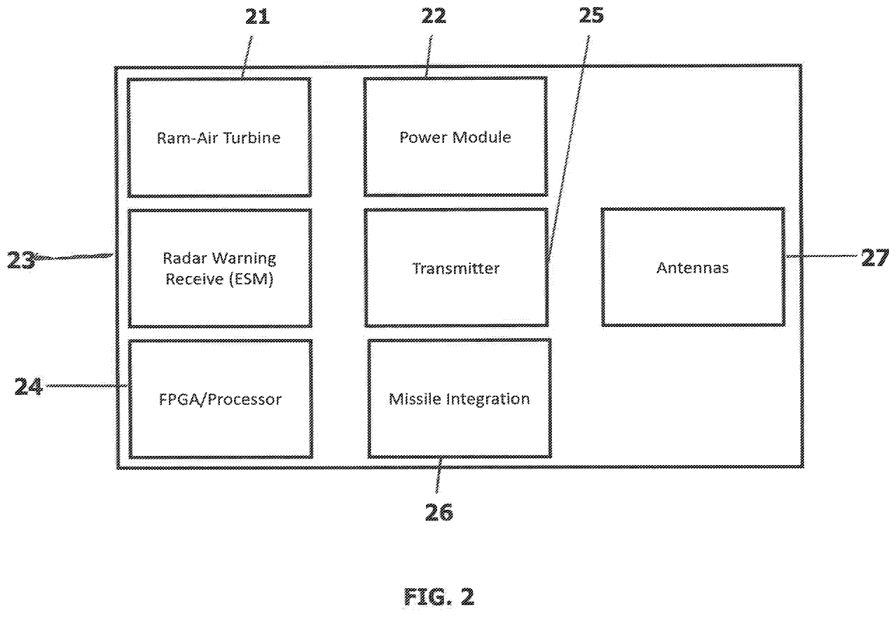

The EW pod itself may be functionally conventional and, as illustrated in FIG. 2 may comprise: a ram-air turbine power source 21; a power module 22 for converting the source power to appropriate voltage levels for the pod components; a radar warning receiver 23 for receiving enemy radar signals; a signal processor 24 which processes the received enemy radar signals and is programmed by a central control site with search and collection instructions; one or more transmitters 25 controlled by the signal processor 24 for generating the requisite jamming signals in response to receiving enemy radar signals; missile integration circuitry 26 for incorporating the pod into the missile; and antennas 27 for receiving enemy radar signals and transmitting jamming signals back to the enemy radar signal source. Examples of similar pods are disclosed in the aforementioned Keegan et al published patent application, as well as in U.S. Pat. No. 6,697,008 (Sternowski), U.S. Pat. No. 6,933,877 (Halladay et al), and U.S. Pat. No. 7,653,196 (Higgins), the entire disclosures in which are incorporated herein by reference.

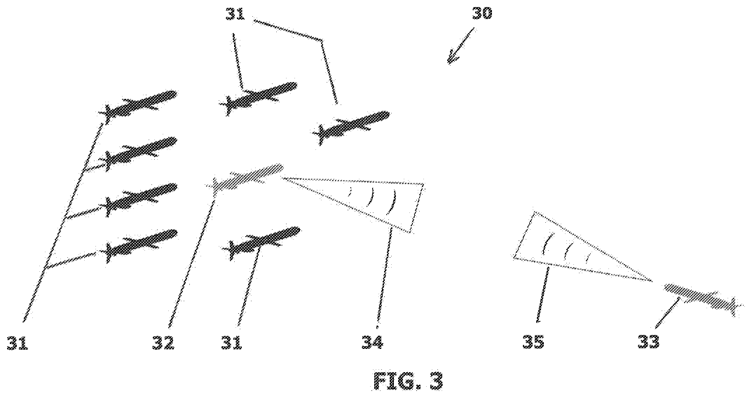

A typical strike package incorporating the EP missile 10 described above is illustrated in FIG. 3 wherein a missile strike package 30 includes a plurality of armed missiles 31 accompanied on a mission by an electronic protection (EP) missile 32. Upon receiving and detecting an enemy radar signal 35, the EW pod in EP missile 32 transmits an appropriate jamming signal 34 back toward the source of the detected signal, which source may be an enemy missile 33 (as shown), an airplane, or a shipboard or land-based radar system.

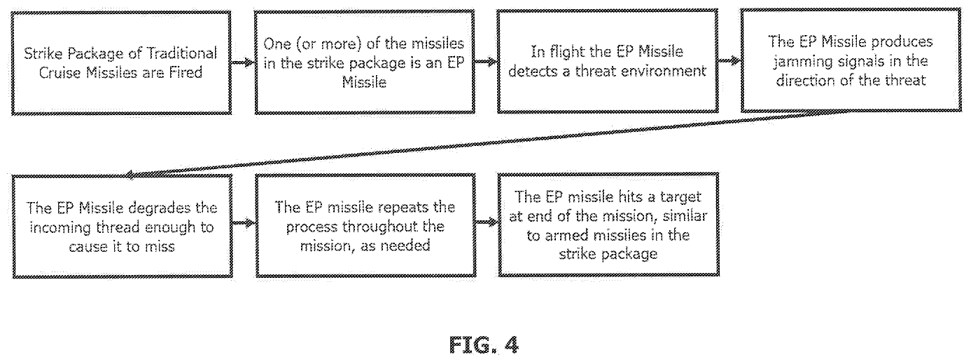

A typical sequence of events in a typical missile strike package mission employing the EP missile is illustrated in FIG. 4. More specifically, the armed missiles in the strike package are fired and are accompanied by one or more EP missiles. During the mission the EP missile detects a threat in the form, for example, of an incoming enemy missile transmitting a homing signal toward a missile in the strike package. In response, the EP missile generates jamming signals and transmits them in the direction of the source of the threat, degrading the incoming threat sufficiently to cause it to miss the armed missiles in the strike package. If other threats are detected during the mission, the EP missile repeats the response. At the end of the mission the EP missile may be directed to impact one of the mission targets.

As described above, a primary aspect of this disclosure is the placement of an EW pod in missile in the space that was occupied by or is designed for the missile warhead, thereby converting the missile to, or creating the missile as an unarmed electronic protection (EP) missile suitable for accompanying and protecting armed missiles as part of a multiple missile strike package. The end result is a significant reduction of the number of missiles in the package that are likely to be destroyed by enemy countermeasures. Any costs associated with the EW pod are justified by the reduction in the number of armed missiles required to complete the intended mission. Moreover, since only one missile, the protection missile, is necessary to provide protection, there is no need to retrofit each missile, thereby providing an even greater cost saving to effect long-range in-flight protection.

This EP missile, by being in relatively close proximity to the armed missiles in flight, provide a self-protect jamming function for the entire group of missiles. In addition, the radar warning receiver in the EW pod may be configured to change the flight paths for some or all of the armed missiles mid-mission to avoid enemy threats.

The EP missile is capable of protecting any missile(s) used for long range strikes. Conventional EW protection extends only about five hundred miles while, long range missiles have ranges far beyond that. The EP missile is focused on creating a moving protection platform that can be placed on any missile such that it protects a group of missiles at any range. Importantly, the EP missile can detect potential threats and change course based on those detected threats.

Typically, for protection of the missile package, cruise missile deployment in a missile package would have the missile locations dispersed, thereby limiting the ability of a single EW asset to protect the entire package. The EP missile disclosed herein protects all of the missiles in the package while travelling as part of the package. As a result, missions can be planned and carried out without the need to design for and effect dispersion.

The EP missile may be used to protect assets other than missile packages. For example, the EP missile may be controlled to fly in prescribed patterns over some land or sea-based assets, or slower moving aircraft, to protect them.

The protection range of the EP missile is determined by its jamming to signal ratio, which is the ratio of the power of a jamming signal to that of the signal at the threat receiver. This ratio is heavily dependent on the power capability of the jammer which for purposes of the disclosed system can be designed with mission requirements in mind.

It is to be noted that the primary feature of the present disclosure pertains to replacing the warhead of a missile with an electronic warfare (EW) pod designed to overcome enemy countermeasures applied against the missile, and that fits within the space designed to be occupied by the warhead.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A cruise missile system comprising:
an aerodynamic missile body;
a propulsion subsystem disposed in said missile body;
a missile control subsystem disposed in said missile body;
a fuel tank disposed in said missile body;
a warhead space in said missile body configured to receive a warhead; and
an electronic warfare pod disposed in said warhead space instead of a warhead.

2. The cruise missile system of claim 1 wherein said electronic warfare pod comprises means for detecting enemy radar signals and transmitting jamming signals to counter the enemy radar signals.

3. The cruise missile system of claim 1 wherein said electronic warfare pod comprises:
a power source;
a power module for converting source power from the power source to voltage levels for use by components of the warfare pod;
a radar warning receiver for receiving enemy radar signals;
a signal processor for processing the received enemy radar signals;
one or more transmitters controlled by the signal processor for generating jamming signals in response to received enemy radar signals;
missile integration circuitry for incorporating the pod into the missile; and
antennas for receiving the enemy radar signals and transmitting the jamming signals.

4. The cruise missile system of claim 3 wherein said missile control system comprises:
a targeting subsystem located at the forward end of the missile body and navigation subsystem located rearward of the targeting system, wherein the targeting and navigation subsystems include one or more of the following capabilities: inertial guidance (IGS); Terrain Control Matching (TERCOM); Global Positioning (GPS) and Digital Scene Matching Area Correlation (DSMAC).

5. The cruise missile of claim 3 deployed as a protection missile in and for a long-range missile strike package along with multiple armed missiles of like configuration but wherein the warhead spaces in the armed missiles contain respective warheads instead of electronic warfare pods.

6. The cruise missile system of claim 1 wherein said missile control system comprises:
a targeting subsystem located at the forward end of the missile body and navigation subsystem located rearward of the targeting system, wherein the targeting and navigation subsystems include one or more of the following capabilities: inertial guidance (IGS); Terrain Control Matching (TERCOM); Global Positioning (GPS) and Digital Scene Matching Area Correlation (DSMAC).

7. The cruise missile of claim 1 deployed as a protection missile in and for a long-range missile strike package along with multiple armed missiles of like configuration and form factor but wherein the warhead spaces in the armed missiles contain respective warheads instead of electronic warfare pods.

8. A method of retrofitting a cruise missile for use as a protection missile as part of a long-range missile strike package comprising:
removing the warhead from the cruise missile; and
placing an electronic warfare pod in the space previously occupied by the removed warhead.

9. The method of claim 8 further comprising:
deploying the protection missile in a long-range missile strike package along with multiple armed missiles of like configuration but wherein the warhead spaces in the armed missiles contain respective warheads instead of electronic warfare pods.

10. The method of claim 8 further comprising providing said electronic warfare pod with a power source, a power module configured to convert source power from the power source to voltage levels for use by components of the warfare pod, a radar warning receiver for receiving enemy radar signals, a signal processor for processing the received enemy radar signals, one or electronic more transmitters controlled by the signal processor for generating jamming signals in response to received enemy radar signals, missile integration circuitry for incorporating the pod into the missile, and antennas for receiving the enemy radar signals and transmitting the jamming signals.

11. The method of claim 10 wherein the electronic warfare pod communicates with the armed missiles to cause any or all of the armed missiles to change flight paths during a mission to avoid enemy threats.

12. A long-range missile strike package comprising:
multiple armed missiles and one protection missile, all of like construction and form factor, each including an aerodynamic missile body, a propulsion subsystem disposed in the missile body; a missile control subsystem disposed in said missile body, a fuel tank disposed in said missile body; and a warhead space in said missile body configured to receive a warhead;
wherein each of said armed missiles contains a warhead in said warhead space; and
wherein an electronic warfare pod is disposed in the warhead space of the protection missile instead of a warhead.

13. The long-range missile strike package of claim 12 wherein the electronic warfare pod comprises:
a power source;
a power module for converting source power from the power source to voltage levels for use by components of the electronic warfare pod;
a radar warning receiver for receiving enemy radar signals;
a signal processor for processing the received enemy radar signals;
one or more transmitters controlled by the signal processor for generating jamming signals in response to received enemy radar signals;
missile integration circuitry for incorporating the pod into the missile; and
antennas for receiving the enemy radar signals and transmitting the jamming signals.

14. The long-range missile strike package of claim 13 wherein the electronic warfare pod includes means for communicating with the armed missiles to cause any or all of them to change flight paths during a mission to avoid enemy threats.
